(19) United States
(12) Patent Application Publication
(10) Pub. No.: US 2006/0165906 A1
(43) Pub. Date: Jul. 27, 2006

(54) Manufacturing method of a floor pad that has antibacterial and anti static electricity functions

(76) Inventor: Ying-Chou Wei, Tanzih Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/041,567

(22) Filed: Jan. 24, 2005

(51) Int. Cl. B05D 3/02; B05D 1/12; B05D 1/36

(52) U.S. Cl. 427/393.1; 427/180; 427/402

(57) ABSTRACT

A manufacturing method of a floor pad that has antibacterial and anti static electricity functions firstly forms a substrate layer that is made of EVA, plastic material or wood. The top of the substrate layer is applied a layer of paint that contains nano powdered metal mineral crystal. The layer of paint forms an antibacterial and anti static electricity surface after being baked and hardened.

### BACKGROUND OF THE INVENTION

1. Field of the Invention

The present invention relates to manufacturing method of a floor pad, and more particularly to a manufacturing method of a floor pad that has antibacterial and anti static electricity functions.

2. Description of Related Art

A conventional floor pad usually made of EVA, artificial plastic material wood. The conventional floor pad may cause a lot of static electricity due to a friction when walking of playing thereon. According to some medical report, a great quantity of static electricity may influence the normal breath of human's skin. However, the marketed anti static electricity floor pad usually is disposed a conducting layer between the floor pad and the ground for causing a ground conduction to removing static electricity. As a result, the floor pad becomes not flexible and hard to be built. In addition, the marketed anti static electricity floor pad has complicated manufacturing process and a high price.

Furthermore, the static electricity may cause an electromagnetic phenomenon to the floor pad. As a result, the dust and germs may be adhered on the floor pad and the dust and germs usually are the over-sensitive source of children. Consequently, the conventional floor pads need to be advantageously altered.

The present invention has arisen to mitigate and/or obviate the disadvantages of the conventional floor pads.

### SUMMARY OF THE INVENTION

The main objective of the present invention is to provide an improved manufacturing method of a floor pad that has antibacterial and anti static electricity functions.

To achieve the objective, the manufacturing method in accordance with the present invention firstly forms a substrate layer that is made of EVA, plastic material or wood. The top of the substrate layer is applied a layer of paint that contains nano powdered metal mineral crystal. The layer of paint forms an antibacterial and anti static electricity surface after being baked and hardened.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of the manufacturing method in accordance with the present invention;

FIG. 2 is a perspective view of a floor that is made of the manufacturing method in FIG. 1; and

FIG. 3 is a cross-sectional view of the floor pad in FIG. 2.

### DETAILED DESCRIPTION OF THE INVENTION

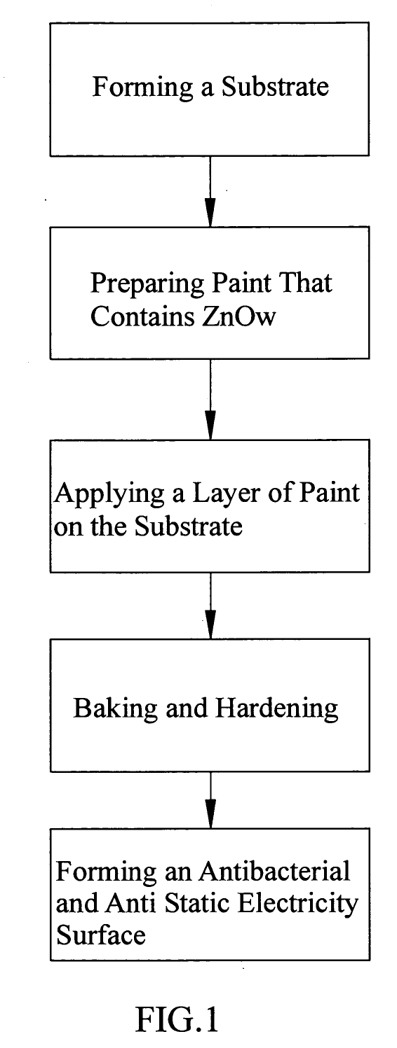

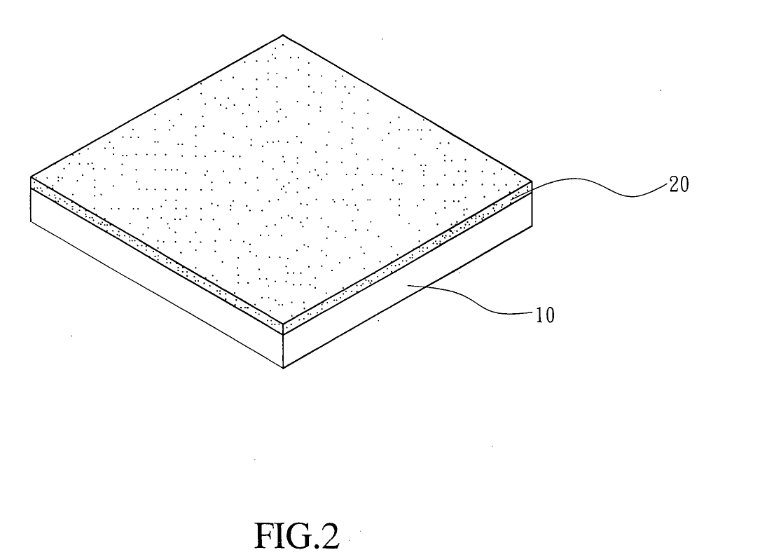

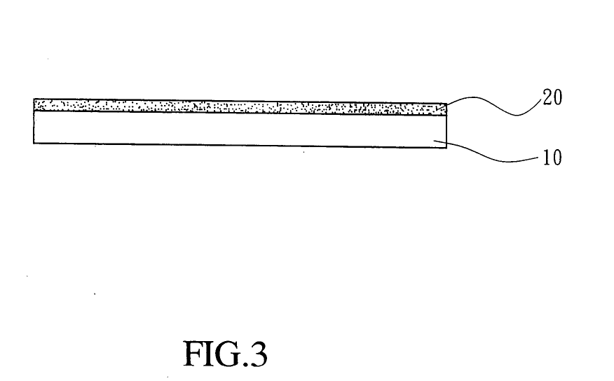

Referring to the drawings and initially to FIGS. 1-3, a manufacturing method of a floor pad that has antibacterial and anti static electricity functions in accordance with the present invention firstly forms a substrate layer (10) that is made of EVA, plastic material or wood. The top of the substrate layer (10) is applied a layer of paint that contains nano powdered metal mineral crystal. The layer of paint forms an antibacterial and anti static electricity surface (20) after being baked and hardened.

The above metal mineral crystal is ZnOw (Tetrapod-shaped Zinc Whisker) that is a macromolecule material for anti static electricity. The top of the whisker of the ZnOw will cause an electric nucleon mass effect and a fowlerordheim such that the ZnOw has an electric conductivity that is provided for dispersing the static electricity formed on the floor pad.

As well know, a bacterium is coated by a layer of cell wall that is provided for maintain a shape of the bacterium and protecting the bacterium. Most of the antibiotics, such as penicillin, are provided for restraining the peptidoglycon in the cell wall. As a result, the bacterium can not compose cell wall and be survival because it loses the protection from the cell wall. That is, the bacteria can be eliminated by destroying their cell wall.

The nano powdered ZnOw has tetrapod-shaped whisker that has the ability to prick with the cell wall of the bacteria. Consequently, the tetrapod-shaped whisker successfully pricks the cell wall of the bacteria when the bacteria dash against the exposed tetrapod-shaped whisker on the anti static electricity surface (20) of the floor pad in accordance with the present invention for achieving the antibacterial purpose. After testing, the floor pad of the present invention is very effective against salmonella, staphylococcus aureus and candidiasis albicans.

As described above, the floor pad in accordance with the present invention has the advantages as followed.

1. Easily manufactured: the ZnOw is mixed into the paint that is applied on the top of the substrate layer. The ZnOw has an electric conductivity that is provided for dispersing the static electricity formed on the floor pad.

2. The tetrapod-shaped whisker successfully pricks the cell wall of the bacteria and achieves the antibacterial purpose.

3. The floor pad of the present invention maintains the flexible characteristic such that the floor pad of the present invention can be easily built.

Although the invention has been explained in relation to its preferred embodiment, it is to be understood that many other possible modifications and variations can be made without departing from the spirit and scope of the invention as hereinafter claimed.

What is claimed is:

1. A manufacturing method of a floor pad that has antibacterial and anti static electricity functions, comprising the steps of:
forming a substrate layer;
applying a later of paint on a top of the substrate layer, wherein the paint contains nano powdered metal mineral crystal;
baking and hardening the substrate layer; and
forming an antibacterial and anti static electricity surface on the substrate layer due to the layer of paint.

2. The manufacturing method as claimed in claim 1, wherein the metal mineral crystal is ZnOw (Tetrapod-shaped Zinc Whisker) that is a macromolecule material for anti static electricity, the top of the whisker of the ZnOw causing an electric nucleon mass effect and a fowlerordheim such that the ZnOw has an electric conductivity that is provided for dispersing the static electricity formed on the floor pad.

3. The manufacturing method as claimed in claim 2, wherein the tetrapod-shaped whisker successfully pricks a cell wall of bacteria when the bacteria dash against the exposed tetrapod-shaped whisker on the anti static electricity surface.

4. The manufacturing method as claimed in claim 3, wherein the bacteria are salmonellas.

5. The manufacturing method as claimed in claim 3, wherein the bacteria are staphylococcus aureus.

6. The manufacturing method as claimed in claim 3, wherein the bacteria are candidiasis albicans
